(19) United States
(12) Patent Application Publication
(10) Pub. No.: US 2025/0036211 A1
(43) Pub. Date: Jan. 30, 2025

(54) UNIVERSAL TRACKING OF PHYSICAL OBJECTS IN AN EXTENDED REALITY ENVIRONMENT

(71) Applicant: Street Smarts VR, Inc., New York, NY (US)

(72) Inventors: Greg Prodzenko, New York, NY (US); Derek Kearney, New York, NY (US); Andy Quay, New York, NY (US); Halley McCole, New York, NY (US); Mike Vamer, New York, NY (US); Jeff Jarrard, New York, NY (US)

(21) Appl. No.: 18/786,307

(22) Filed: Jul. 26, 2024

Related U.S. Application Data
(60) Provisional application No. 63/529,338, filed on Jul. 27, 2023.

(51) Int. Cl. G06F 3/0346; G01D 5/14; G06T 19/00; G09B 9/00

(52) U.S. Cl. CPC G06F 3/0346; G01D 5/14; G06T 19/00; G09B 9/003; G06T 2219/024

(57) ABSTRACT

Numerous examples are disclosed of a system and method for universal tracking of physical objects in a physical environment and generating accurate virtual counterparts within an extended reality (XR) environment. In one example, a magnetic tracking system comprises a first XR device to generate a XR environment for a first user, an electromagnetic field (EMF) source to generate EMF, a first tracked object, and a first magnetic sensor physically coupled to the first tracked object to receive the EMF and generate a first sequence of tracking data, wherein the XR environment generates a first virtual counterpart to the first tracked object.

### PRIORITY CLAIM

This application claims priority to U.S. Provisional Patent Application No. 63/529,338, filed on Jul. 27, 2023, and titled, “Universal Tracking,” which is incorporated by reference herein.

### FIELD OF THE INVENTION

Numerous examples are disclosed of a system and method for universal tracking of physical objects in a physical environment and generating accurate virtual counterparts within an extended reality (XR) environment.

### BACKGROUND OF THE INVENTION

XR environments are becoming increasingly prevalent. An XR environment can include one or more of a virtual reality (VR) environment, an augmented reality (AR) environment, and a mixed reality (MR) environment. An XR environment can include a computer-generated simulation of a three-dimensional image or environment that a human user can interact with using physical equipment, such as a helmet with goggles that generate graphics on a screen viewed by the user and a controller fitted with sensors.

As used herein, a “physical object” is an object that exists in the physical environment of the user. In some instances, the physical environment is a bounded area. A physical object often will have a virtual, graphical counterpart object in the XR environment. For example, if the user holds a physical gun, the XR environment sometimes will display a graphical gun within the XR environment. One key challenge in this situation is for the XR environment to accurately track the physical object so that its virtual counterpart is displayed in the XR environment in an accurate location and so that movements of the virtual counterpart in the XR environment mirror the location and movements of the physical object in the physical environment.

The prior art includes three types of approaches to tracking physical objects in a XR environment. A first approach utilizes “outside—in” optical markers where fixed physical beacons are placed in a playspace (e.g., a bounded physical space in which the user can operate) so that the XR system will be able to track the physical space. A second approach utilizes “inside-out” markers, where optical markers are placed on the tracked objects. A video camera either on the XR headset or fixed in the playset monitor the optical monitors and calculate where the tracked objects are located. A third approach utilizes dead reckoning with an internal inertial measurement unit (IMU), where no markers are used and sensors measure the acceleration and angular velocity of the tracked object. This data can be used to calculate how much the device has moved from a previous point in space.

The three prior art approaches have drawbacks and limitations. For the “outside—in” and “inside-out” approaches, the playspace is constrained to a fixed location based on the placement of the physical beacons, and the tracked objects must have a clear line-of-sight to the optical cameras or beacons. If there is an object, such as a physical wall, between the tracked object and the beacon in the “outside—in” approach or between the tracked object and the camera in the “inside-out approach,” then the tracked object cannot be tracked. The dead reckoning IMU approach is subject to drift due to accumulated errors, and dead reckoning with an IMU performs poorly when subjected to high acceleration or vibration.

These drawbacks and limitations are particularly problematic for XR-based training such as the types of training done by law enforcement, military, and first responders. For example, trainees want weapons that recoil since this increases training effectiveness by providing a more immersive experience. However, dead reckoning is not compatible with recoiling weapons because the accelerations due to recoil will cause significant errors to the dead reckoning calculation. Trainees also need to train for real world situations, which means training in buildings, in large spaces, and around obstacles. Trainees must learn the skills of properly traversing multiple floors, large spaces, and physically interacting with their environment such as leaning against walls. However, inside-out and outside—in tracking are incompatible with this kind of training because these methods require line of sight between the tracked objects and the reference device.

The prior art also includes magnetic tracking systems, such as a product known as “AMFITRACK” offered by a company named “AMFITECH,” that include a source device that generates an electromagnetic field (EMF) and sensors that receive and measure the EMF, which allows the position of each sensor to be determined. Unlike optical signals, EMF can pass through non-metallic objects. To date, magnetic tracking systems have not been used in XR-based training systems.

What is needed is an improved XR-based training system for tracking physical objects in a XR environment that overcomes the challenges of the prior art.

### SUMMARY OF THE INVENTION

Numerous examples are disclosed of a system and method for universal tracking of physical objects in a physical environment and generating accurate virtual counterparts within a virtual reality (XR) environment.

### BRIEF DESCRIPTION OF THE DRAWINGS

FIG. 1 depicts a magnetic tracking system.

FIG. 2 depicts a magnetic tracking system in a physical environment.

FIG. 3 depicts a magnetic tracking system in another physical environment.

FIG. 4 depicts another magnetic tracking system.

FIG. 5 depicts a plurality of magnetic tracking systems.

### DETAILED DESCRIPTION OF THE INVENTION

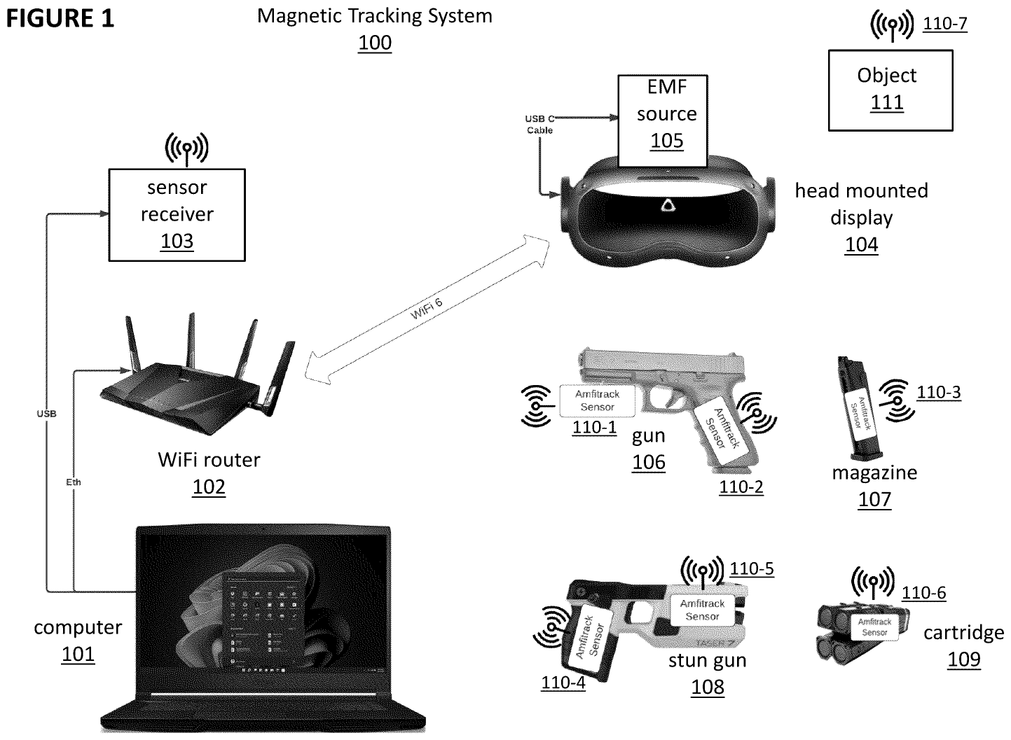

FIG. 1 depicts magnetic tracking system 100, which is a first embodiment of a magnetic tracking system. Magnetic tracking system 100 comprises computer 101, WiFi router 102, sensor receiver 103, head mounted display 104, EMF source 105, gun 106, magazine 107, stun gun 108 (such as a stun gun known by the name “TASER”), cartridge 109, object 111, and magnetic sensors 110-1, 110-2, 110-3, 110-4, 110-5, 110-6, and 110-7. Computer 101 communicates with WiFi router 102 over an Ethernet cable or other interface and with sensor receiver 103 over a USB connection or other interface. WiFi router communicates with head mounted display 104 over WiFi.

In the example shown, a single gun 106, a single replacement magazine 107 for gun 106, a single stun gun 108, and a single replacement cartridge 109 for stun gun 108 are shown, but these devices are merely examples and any number of these items, or none at all, can be used in magnetic tracking system 100. Object 111 is any physical object whose location is to be tracked. Object 111, for example, can be a part of the user's body, a wall, a chair, a target, etc.

Magnetic sensor 110-1 is physically coupled to gun 106, magnetic sensor 110-2 is physically coupled to a magazine (not shown) that is inserted in gun 106, magnetic sensor 110-3 is physically coupled to magazine 107 (which here is an extra magazine for gun 106), magnetic sensor 110-4 is physically coupled to stun gun 108, magnetic sensor 110-5 is physically coupled to a taser cartridge (not shown) that is inserted in stun gun 108, magnetic sensor 110-4 is physically coupled to cartridge 109 (which here is an extra cartridge for stun gun 108), and magnetic sensor 110-7 is physically coupled to object 111. Additional magnetic sensors can be physically coupled to these physical objects. The magnetic sensors 110 can be secured to the outside of the physical object or they can be embedded within certain physical objects since EMF can penetrate non-metallic objects.

Optionally, additional types of trackers (not shown) can be attached to one or more of the physical objects, such as magnetometers, IMUs, gyroscopes, optical emitters and/or sensors, LIDAR, ultrasonic emitters and/or sensors, RF transceivers, ultra wideband transceivers, Bluetooth transceivers, WiFi transceivers, and RFID transceivers.

During operation, computer 101 runs software to generate a XR environment in head mounted display 104 over WiFi router 102. The user who is wearing head mounted display 104 will physically see a XR environment on a screen (not shown) on the inside of head mounted display 104. Optionally, XR counterparts to gun 106, magazine 107, stun gun 108, cartridge 109, and object 111 are generated in the XR environment. For example, if the user is physically holding gun 106, a graphical depiction of gun 106 might be generated in XR environment.

EMF source 105 emits EMF. Sensors 110-1, 110-2, 110-3, 110-4, 110-5, 110-6, and 110-7 determine an absolute position (identified with x, y, and z coordinate data) and orientation (identified with pitch, yaw, and roll data) of the sensor—and by extension the object that it is physically coupled to—relative to each other and relative to EMF source 105 and transmit that data to sensor receiver 103, which in turn provides the data to computer 101 that in turn modifies virtual counterparts in the XR display in head mounted display 104 in response to any changes in position and orientation of each sensor and object to which the sensor is physically coupled.

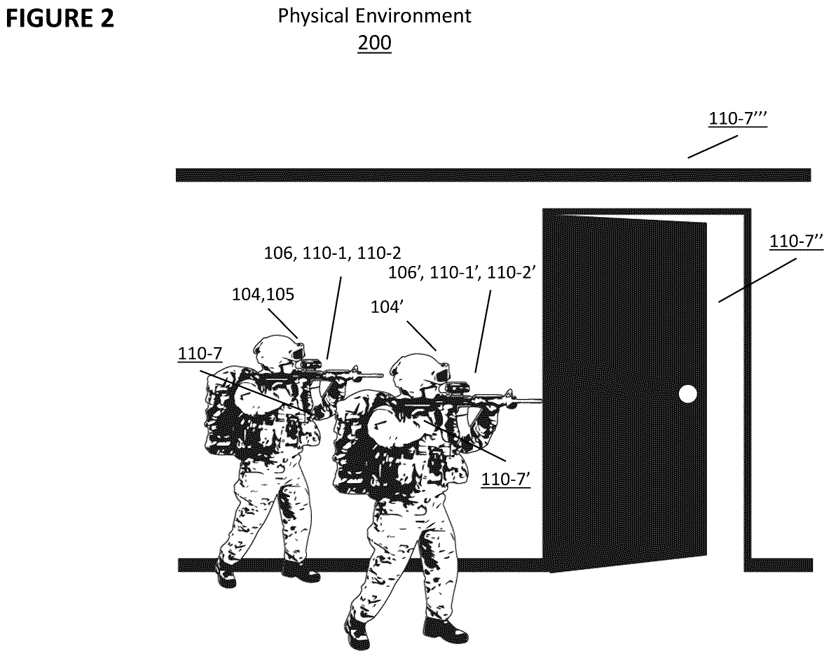

FIG. 2 depicts an example of magnetic tracking system 100 implemented in physical environment 200 that might be use for training of law enforcement or military personnel. A first user on the left wears head mounted display 104 with EMF source 105 and holds gun 106 with magnetic sensors 110-1 and 110-2 as explained with respect to FIG. 1. The first user also has magnetic sensors 110-7 attached to his wrists so that his wrists can be tracked and displayed in virtual form in the virtual environment. A second user to the right of the first user wears head mounted display 104′ and holds gun 106′ with magnetic sensors 110-1′ and 110-2′. The second user also has magnetic sensors 110-7′ attached to his wrists so that his wrists can be tracked and displayed in virtual form in the virtual environment. In this example, the second user does not have an EMF source attached to his head mounted display because the second user is part of the same XR environment as the first user and can rely on the EMF source 105 attached to the head mounted display 104 worn by the first user.

In this example, magnetic sensor 110-7″ and 110-7 [symbol] are also attached to a door and a wall, respectively, so that those items can be tracked within the XR environment. This allows the first user and the second user to interact with those items, for example, by touching and opening the door, and computer 101 then can move a virtual counterpart to the door in the XR environment in a way that mirrors the movement of the physical door using the data sent by the magnetic sensor 110-7″ to sensor receiver 103. Because EMF can travel through non-metallic objects, the XR environment will be able to track items that are on the other side of the wall in FIG. 2, as the EMF from EMF source 105 will penetrate the wall.

Optionally, guns 106 and 106′ can recoil like they would recoil in the physical world outside of a training environment. Unlike in prior art systems, magnetic sensors 110-1, 110-2, 110-1′, and 110-2′ will be able to track the movement of the recoil and accurately capture data relating to that movement such that computer 101 will be able to mirror that movement for virtual counterparts to guns 106 in the XR environment. Optionally, recoil data can be provided by other devices, such as switches or buttons connected to the trigger or other component of the gun.

Optionally, magnetic sensors 110-2 and 110-2′ can be configured to inject a stoppage when the magazine in inserted into guns 106 and 106′, respectively, thereby simulating the feeling of loading a cartridge into a gun in the physical world.

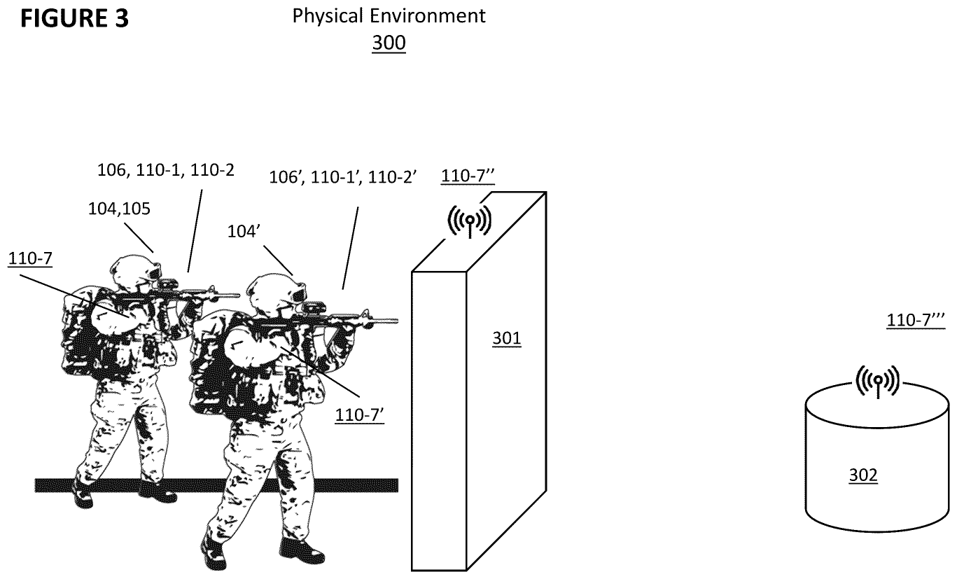

FIG. 3 depicts physical environment 300. The first user and the second user are equipped as in physical environment 200 in FIG. 2. Magnetic sensor 110-7″ is physically coupled to physical object 302, and magnetic sensor 110-7 [symbol] is physically coupled to physical object 301. Notably, physically object 301 completely blocks physical object 302 from the line of sight of the first user and the second user. Nevertheless, sensor 110-7 [symbol] is able to receive EMF from EMF source 105 and generate a sequence of data despite the presence of object 301.

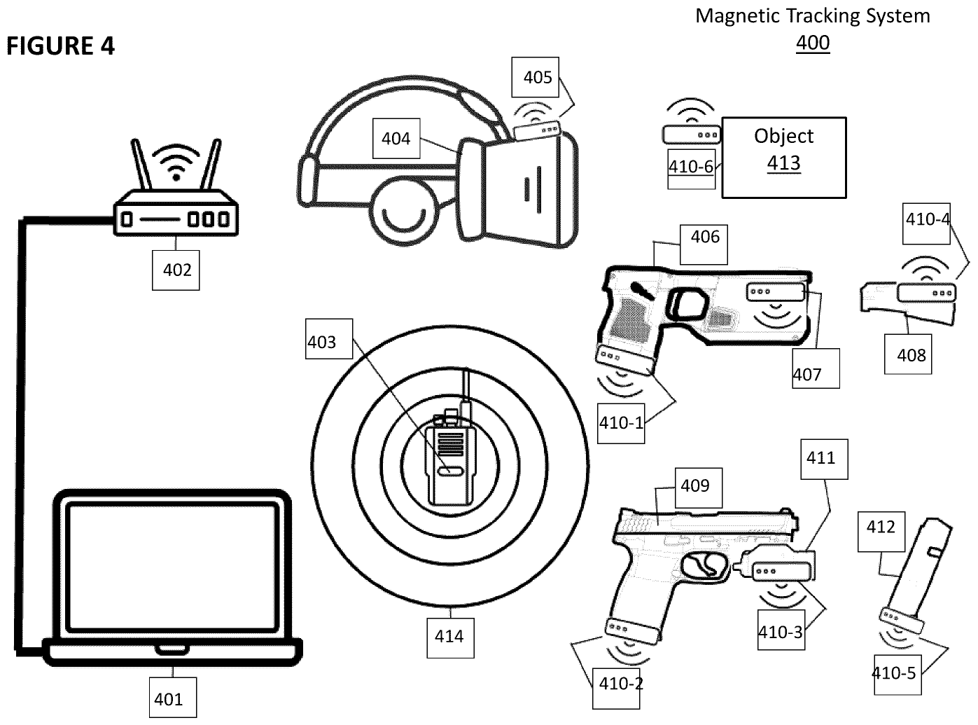

FIG. 4 depicts magnetic tracking system 400, which is a second embodiment of a magnetic tracking system. Magnetic tracking system 400 comprises computer 401, WiFi router 402, EMF source 403, head mounted display 404, sensor hub 405, electronic control device replica 406, cartridge 407, cartridge 408, gun 409 (such as a service weapon or training replica), rail mounted tactical light enclosure 411, magazine 412, object 413, and magnetic sensors 410-1, 410-2, 410-3, 410-4, 410-5, and 410-6.

In the example shown, a single electronic control device replica 406, a single cartridge 408, a single gun 409, and a single magazine 412 for gun 409 are shown, but these devices are merely examples and any number of these items, or none at all, can be used in magnetic tracking system 400. Object 413 is any physical object whose location is to be tracked. Object 413, for example, can be a part of the user's body, a wall, a chair, a target, etc.

In one embodiment, magnetic sensor 410-1 is physically coupled to electronic control device replica 406, magnetic sensor 410-2 is physically coupled to a magazine (not shown) that is inserted in gun 409, magnetic sensor 410-3 is physically coupled to rail mounted tactical light enclosure 411, Magnetic sensor 410-4 is physically coupled to cartridge 408, magnetic sensor 410-5 is physically coupled to magazine 412, and magnetic sensor 410-6 is physically coupled to object 413. Additional magnetic sensors can be physically coupled to these physical objects. Each magnetic sensor 410 can be secured to the outside of the physical object or they can be embedded within certain physical objects since EMF can penetrate non-metallic objects.

Optionally, additional types of trackers (not shown) can be attached to one or more of the physical objects, such as magnetometers, IMUs, gyroscopes, optical emitters and/or sensors, LIDAR, ultrasonic emitters and/or sensors, RF transceivers, ultra wideband transceivers, Bluetooth transceivers, WiFi transceivers, and RFID transceivers.

During operation, computer 401 runs a software application to generate a XR environment in head mounted display 404 over WiFi router 402. The user who is wearing head mounted display 404 will physically see a XR environment on a screen (not shown) on the inside of head mounted display 404. Optionally, XR counterparts to electronic control device replica 406, cartridge 407, cartridge 408, gun 409 (such as a service weapon or training replica), cartridge 411, rail mounted tactical light enclosure 411, magazine 412, and object 413 are generated in the XR environment. For example, if the user is physically holding gun 409, a graphical depiction of gun 409 might be generated in XR environment.

EMF source 403 emits EMF. Magnetic sensors 410-1, 410-2, 410-3, 410-4, 410-5, and 410-6 determine an absolute position (identified with x, y, and z coordinate data) and orientation (identified with pitch, yaw, and roll data) of the sensor—and by extension the object that it is physically coupled to—relative to each other and relative to EMF source 403 and transmit that data to sensor hub 405, which in turn provides the data to computer 101 that in turn modifies virtual counterparts in the XR display in head mounted display 404 in response to any changes in position and orientation of each sensor and object to which the sensor is physically coupled.

Sensor hub 405 is mounted to the outside of head mounted display 404 and acts as a central receiving hub for data from magnetic sensors 410-1, 410-2, 410-3, 410-4, 410-5, and 410-6. EMF source 403 is concealed inside a radio shaped enclosure and worn either on the belt or a vest. EMF source 403 produces a tracking sphere approximately two meters in diameter, which will surround the user if the is wearing EMF source 403. Visualization 414 of the EMF sphere shows the representation of the magnetic field lines used by the tracking system to “triangulate” objects within this field. As the user moves within the physical environment, this wearable tracking system moves along with them. The relative positions and orientations of magnetic sensors 410-1, 410-2, 410-3, 410-4, 410-5, and 410-6 are calculated and returned to computer 401.

Electronic control device replica 406 contains magnetic sensor 410-1 integrated inside the device. Cartridge 407 inside contains its own magnetic sensor (not shown) that is used to determine if the cartridge has been reloaded. The small form factor and ability to conceal the sensor inside plastic allows the magnetic sensor 410-4 to fit within the Cartridge shaped enclosure 408 to maintain the look and feel of the real cartridge. Any type of gun 409 may be used with the training system, including service weapons using drop in recoil conversion kits. The magnetic sensor 410-5 inside the magazine 412 can be loaded into the weapon and this smart magazine can be configured to detect fire events, count rounds, and inject stoppage to simulate jams or empty magazines. The Rail mounted tactical light enclosure 411 holds magnetic sensor 410-3 inside. When the recoiling weapon is fired, the movement of the recoil event is captured on magnetic sensor 410-3 and a shot fire event is sent back to computer 401 and inserted into the simulation. This shot detection method is novel as it allows the tactical light 411 to be rail mounted to any compatible recoil training weapon with no need to modify the existing training device. This allows users to convert their service weapon into a training device using only an off-the-shelf drop in recoil kit and rail mounted magnetic sensors 410-3. Optionally, recoil data can be provided by other devices, such as switches or buttons connected to the trigger or other component of the gun. The form factor of this enclosure is the same as its real world counterpart, meaning that any holster that accepts pistols with lights will also accept this training device. The magazine shaped enclosure 412 holds the magnetic sensor 410-5 and is used to detect the position and rotation of the magazine while outside of the weapon during reloading.

Each magnetic sensor 410 comprises a dual band radio. In one example, the dual band radio comprises a radio operating at 2.4 GHz and a radio operating below 1 GHz. The latter provides a stable connection that is resilient in challenging environments compare to a device that operates only at 2.4 GHz. The lower frequency is also better at penetrating obstacles like walls or people. This is especially helpful in cases where the user's hand is fully covering the wireless antenna, as is the case when holding the magazine and cartridge or gripping the pistol. In addition to the dual band system, all of the sensors are capable of sending and receiving data to any other sensor in the system. The sensor on the head mounted display 404 is connected to the HMD using a USB-c cable, and the sensor data is read through this port, into the HMD, and sent over WiFi back to the computer. While the primary data path will send data from any object tracking sensor directly to the EMF sensor hub on the HMD, there are secondary paths that can be used to create a mesh network. This mesh network may prove to be more stable and will allow for unique internet of things or IoT implementations for our training devices,

EMF source 403 can be concealed inside anything it will fit into. In the depiction shown in FIG. 4, EMF source 403 is contained within a radio unit, but it can be placed in objects such as ammo pouches, first aid kits, or anything else that a first responder carries on a regular basis. In the example of FIG. 1, the EMF source unit was mounted to the top of the head mounted display. When the user moved and looked around, the magnetic field would shift accordingly. One challenge of the design of FIG. 1 is that all head movement is captured and incorrectly displayed as object movement. In addition, the EMF source is highly susceptible to interference from metal, causing massive accuracy losses and noticeable distortion. Mounting EMF source 403 to the body serves two main functions. The first is to decouple the movement from the HMD with the tracking system. If the user looks side to side, the relative position of the source to the object they are holding does not change, and the simulation shows a steady object that matches the steady object in real life. The second function is to separate the EMF source from interference sources like large metal electronic devices. The user is now able to place the EMF source anywhere on their body using a belt or vest attachment.

The system diagram only shows the recoil pistol and ECD but the tracking system is capable of supporting an array of training devices that can include rifles, shotgun, counter drone devices, and much more. Not shown in the image are other less-lethal training devices such as a baton, OC spray, and flashlight. The small form factor and ability to conceal inside of other devices allows tracking sensors to fit within small handles that are almost completely covered by the user's hand. These smaller devices highlight the advantage this tracking system provides by allowing our training devices to match their real world counterparts in size and shape without the addition of bulky tracking sensors that impede training.

In some embodiments, additional sensors and tracking systems may be used to improve the performance and stability of the universal tracking system. In these cases, off the shelf or custom sensors like computer vision cameras, IR reflecting beacons, or active IR beacons may be used to provide additional accuracy and redundancy. Our system will use dynamic confidence weighting to switch between different sensor types depending on the environmental conditions. For example, when bright sunlight shines into the room and glare affect the machine vision or IR tracking, the system will only use the EMF and IMU data and ignore the optical data. When the EMF sensor detects a large amount of metal and the signal quality drops, the system will rely more heavily on optical tracking data. The goal of the universal tracking system is to provide the most accurate and reliable tracking data to the user, no matter what types or how many sensors are used in the process.

The magnetic sensors typically are calibrated by their manufacturer. Optionally, after the magnetic sensors are installed in their enclosures, the magnetic sensors are calibrated again to account for small changes due to any assembly steps. The most important calibration step occurs when the software in computer 101 or 4041 correlates the coordinate systems between the two distinct tracking systems. For example, head mounted display 404 uses inside out tracking to determine the position of the headset relative to the environment and room around it. The EMF source 403 is the origin for the magnetic sensors 410, and sensor hub 405 mounted to the HMD helps correlate the magnetic sensor coordinates with the head mounted display coordinates within the XR environment. A dynamic smoothing algorithm is used to filter out noise and movements between EMF source 403 and the head mounted display 404.

A novel calibration cube has been proposed to help provide a last step calibration to account for any errors, drift, or tolerances. The calibration cube consists or ArUco markers on each face as well as a magnetic sensor at its center. The geometry of the cube is known and a calibration procedure can be run where the user looks at the cube and manipulates it in front of them. The ArUco markers provide the optical tracking system with an accurate 6 DOF estimate of the cube and the EMF sensor 403 provides its own estimate of the cube. The optical estimate is taken as the true position and a correction factor is used to remove any error between the EMF sensor output and the final 6 DOF output that is used to display the virtual model. This is a proposed solution that can be used as a single use factory calibration or can be provided alongside the system to ensure the system always remains calibrated.

Magnetic tracking system 400 can be used in physical environments 200 and 300 depicted in FIGS. 2 and 3 in the same manner previously described with reference to magnetic tracking system 100.

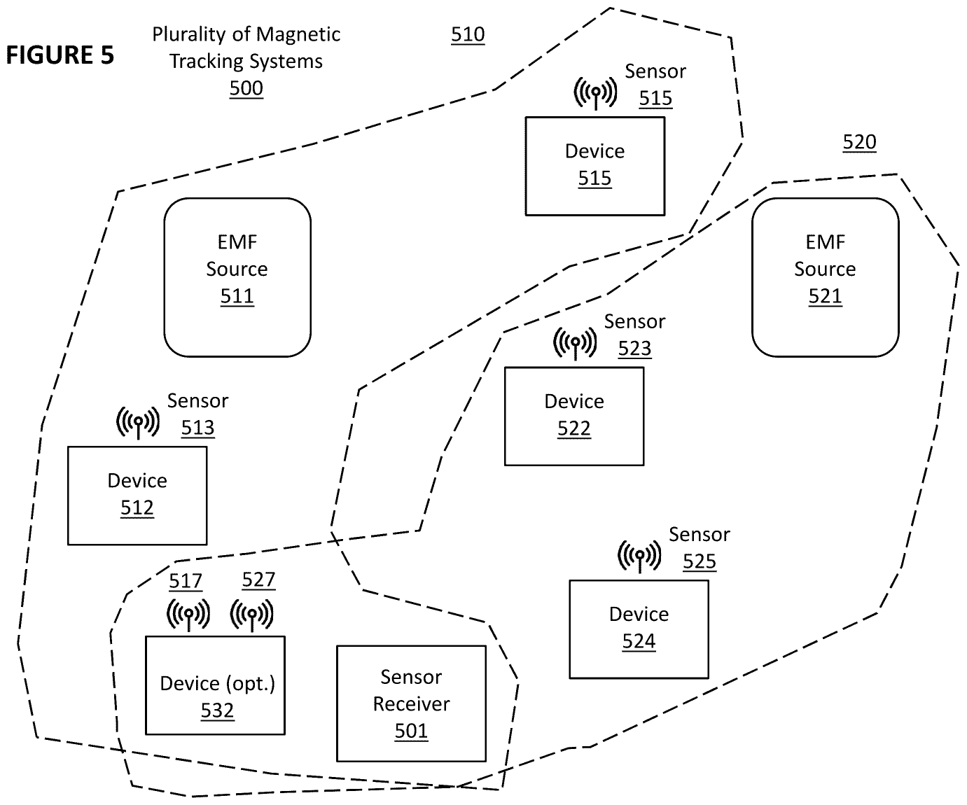

FIG. 5 depicts a plurality of magnetic tracking systems 500, where each magnetic tracking system can be based on the design of magnetic tracking system 100 or magnetic tracking system 400. A first magnetic tracking system 510 comprises EMF source 511, device 512 physically coupled to sensor 513, device 514 physically coupled to sensor 515, and sensor receiver 501. A second magnetic tracking system 552520 comprises EMF source 521, device 522 physically coupled to sensor 523, device 524 physically coupled to sensor 525, and sensor receiver 501. Here, first magnetic tracking system 510 and second magnetic tracking system 52520 share sensor receiver 501. Alternatively, first magnetic tracking system 510 and second magnetic tracking system 52520 can use different sensor receivers. EMF source 511 emits EMF across a first physical space, and EMF source 521 emits EMF across a second physical space that at least partially overlaps with the first physical space. First magnetic system 510 and second magnetic system 52520 operate independently, such that first magnetic system 510 tracks sensors 513 and 515 but not sensors 523 and 525, and second magnetic system 52520 tracks sensors 523 and 525 but not sensors 513 and 515. This allows, for example, two sets of users to share the same physical space for independent training exercises.

Optionally, device 532 is physically coupled to sensor 517 that is part of first magnetic system 510 and sensor 527 that is part of second magnetic system 52520 so that the device is tracked by both first magnetic system 510 and second magnetic system 52520. Sensor 517 generates a first sequence of position and orientation data in response to EMF from EMF source 511 and sends the first sequence of data to sensor receiver 501, and sensor 527 generates a second sequence of position and orientation data in response to EMF from EMF source 521 and sends the second sequence of data to sensor receiver 501. Sensor receiver 501 then sends the data to computer 101 (which operates both virtual environments), or two separate instances of computer 101 (each of which operates a virtual environment).

What is claimed is:

1. A magnetic tracking system comprising:
a first extended reality (XR) device to generate an XR environment for a first user;
an electromagnetic field (EMF) source to generate EMF;
a first tracked object; and
a first magnetic sensor physically coupled to the first tracked object to receive the EMF and generate a first sequence of tracking data;
wherein the XR environment generates a first virtual counterpart to the first tracked object.

2. The magnetic tracking system of claim 1, wherein the XR environment displays a recoil action of the first virtual counterpart that tracks the recoil action of the first tracked object based on the first sequence of tracking data.

3. The system of claim 1, wherein the first XR device comprises head mounted display.

4. The system of claim 1, wherein the EMF source is physically coupled to the XR device.

5. The system of claim 1, wherein the EMF source is not physically coupled to the XR device.

6. The system of claim 1, wherein the first tracked object is a gun.

7. The system of claim 1, wherein the first tracked object is a stun gun.

8. The system of claim 1, comprising:
a second tracked object; and
a magnetic sensor physically coupled to the second tracked object to receive the EMF and generate a second sequence of tracking data.

9. The system of claim 8, wherein the XR environment generates a second virtual counterpart to the second tracked object and displays a recoil action of the second virtual counterpart that tracks the recoil action of the first tracked object based on the second sequence of tracking data.

10. The system of claim 1, comprising:
a second XR device to generate the XR environment for a second user.

11. A plurality of magnetic tracking systems comprising:
a first virtual reality (XR) device to generate a first XR environment for a first user;
a second XR device to generate a second XR environment for a second user;
a first electromagnetic field (EMF) source to generate a first EMF in a first physical space;
a second EMF source to generate a second EMF in a second physical space that at least partially overlaps with the first physical space;
a first tracked object;
a first magnetic sensor physically coupled to the first tracked object to receive the first EMF and generate a first sequence of tracking data;
a second tracked object; and
a second magnetic sensor physically coupled to the second tracked object to receive the second EMF and generate a second sequence of tracking data;
wherein the first XR environment generates a first virtual counterpart to the first tracked object using the first sequence of tracking data; and
wherein the second XR environment generates a second virtual counterpart to the second tracked object using the second sequence of tracking data.

12. The system of claim 11, wherein the XR environment displays a recoil action of the first virtual counterpart that tracks the recoil action of the first tracked object based on the first sequence of tracking data.

13. The system of claim 11, wherein the first XR device comprises head mounted display and the second XR device comprises head mounted display.

14. The system of claim 11, wherein the first EMF source is physically coupled to the first XR device and the second EMF source is physically coupled to the second XR device.

15. The system of claim 11, wherein the first EMF source is not physically coupled to the first XR device and the second EMF source is not physically coupled to the second XR device.

16. The system of claim 11, wherein one or more of the first tracked object and the second tracked object is a gun.

17. The system of claim 11, wherein one or more of the first tracked object and the second tracked object is a stun gun.

18. A method of operating a magnetic tracking system comprising:
generating, by a first virtual reality (XR) device, a XR environment for a first user;
generating, by an electromagnetic field (EMF) source, EMF;
receiving, by a first magnetic sensor physically coupled to a first tracked object, the EMF;
generating, by the first magnetic sensor, a first sequence of tracking data in response to the EMF; and
generating, in the XR environment, a first virtual counterpart to the first tracked object wherein a recoil action of the first virtual counterpart tracks the recoil action of the first tracked object based on the first sequence of tracking data.

19. The method of claim 18, wherein the XR device comprises head mounted display.

20. The method of claim 18, wherein the EMF source is physically coupled to the XR device.

21. The method of claim 18, wherein the EMF source is not physically coupled to the XR device.

22. The method of claim 18, wherein the first tracked object is a gun.

23. The method of claim 18, wherein the first tracked object is a stun gun.

24. The method of claim 18, comprising:
receiving, by a second magnetic sensor physically coupled to a second tracked object, the EMF;
generating, by the second magnetic sensor, a second sequence of tracking data in response to the EMF; and
generating, in the XR environment, a second virtual counterpart to the second tracked object wherein a recoil action of the second virtual counterpart tracks the recoil action of the second tracked object based on the second sequence of tracking data.

25. The method of claim 18, comprising:
generating, by a second XR device, the XR environment for a second user.
